(19) United States
(12) Patent Application Publication
(10) Pub. No.: US 2026/0180370 A1
(43) Pub. Date: Jun. 25, 2026

(54) FRIENDLY METAL LOSS ESTIMATION FOR WIRELESS POWER TRANSFER

(71) Applicant: Apple Inc., Cupertino, CA (US)

(72) Inventors: Zhiyuan Hu, Santa Clara, CA (US); Ruiyang Lin, Milpitas, CA (US); Zhao Yuan, San Jose, CA (US)

(21) Appl. No.: 19/391,035

(22) Filed: Nov. 17, 2025

Related U.S. Application Data
(60) Provisional application No. 63/737,004, filed on Dec. 20, 2024.

(51) Int. Cl. H02J 50/60; H02J 50/10; H02J 50/80

(52) U.S. Cl. CPC H02J 50/60; H02J 50/10; H02J 50/80

(57) ABSTRACT

Determining friendly metal loss in a wireless power transfer device can include measuring one or more observable parameters associated with wireless power transfer between the wireless power transfer device and a counterpart wireless power transfer device; determining flux in a wireless power transfer coil of the wireless power transfer device from the measured one or more observable parameters; and determining friendly metal loss in the wireless power transfer device from the determined magnetic flux. The friendly metal losses can be used to determine and, if necessary, mitigate foreign object loss associated with the wireless power transfer between the wireless power transfer device and the counterpart wireless power transfer device.

### CROSS-REFERENCE TO RELATED APPLICATIONS

This application claims priority to U.S. Provisional Application No. 63/737,004, filed Dec. 20, 2024, which is incorporated by reference herein in its entirety for all purposes.

### BACKGROUND

Wireless power transfer is used in various electronic devices. For example, smart phones, tablet computers, smart watches, wireless earphones, styluses, etc. may employ wireless power transfer to facilitate charging of batteries within the devices and/or to power the devices during operation.

### SUMMARY

A method of determining friendly metal loss in a wireless power transfer device can include measuring one or more observable parameters associated with wireless power transfer between the wireless power transfer device and a counterpart wireless power transfer device; determining flux in a wireless power transfer coil of the wireless power transfer device from the measured one or more observable parameters; and determining friendly metal loss in the wireless power transfer device from the determined magnetic flux. The friendly metal losses can be used to determine and, if necessary, mitigate foreign object loss associated with the wireless power transfer between the wireless power transfer device and the counterpart wireless power transfer device.

The wireless power transfer device can be a wireless power transmitter, and the one or more observable parameters can include one or more parameters selected from the group consisting of: inverter input voltage, inverter output voltage, inverter output current, wireless power transmitting coil current, operating frequency, and capacitance coupled to the wireless power transmitter coil. The wireless power transfer device can be a wireless power receiver, and the one or more observable parameters include one or more parameters selected from the group consisting of: rectifier input voltage, rectifier output voltage, rectifier output current, wireless power receiving coil current, operating frequency, capacitance coupled to the wireless power receiving coil.

Determining flux in the wireless power transfer coil of the wireless power transfer device can be performed in accordance with a formula of the form:

$$\vert ϕ \vert = \frac{\vert V \vert}{N \cdot 2 π {f}_{s}}$$

where |φ| is the RMS value of the magnetic flux, |V| is the RMS voltage across the coil, N is the number of turns in the coil, and fₛ is the frequency of the magnetic flux and voltage. Determining friendly metal loss in the wireless power transfer device from the determined magnetic flux is performed in accordance with a formula of the form:

$${P}_{eddy} = {ϕ}^{2} \cdot {R}_{eddy}$$

where P_{eddy} is the friendly metal loss, φ is the determined magnetic flux, and R_{eddy} is a property of the wireless power transfer device. R_{eddy} can be determined in accordance with a formula of the form:

$${R}_{eddy} = {N}^{2} \cdot \frac{{R}_{a i r} - {R}_{coil\_copper}}{{L}_{a i r}^{2}}$$

where Rₐᵢᵣ is a resistance of the wireless power transfer coil in situ in the wireless power transfer device measured with the wireless power transfer device in free air, R_{coil_copper} is a DC resistance of the wireless power transfer coil, and Lₐᵢᵣ is an inductance of the wireless power transfer coil in situ in the wireless power transfer device measured with the device in free air, and N is the number of turns in the wireless power transfer coil. Rₐᵢᵣ, R_{coil_copper}, Lₐᵢᵣ, and N can be determined during design or manufacture of the wireless power transfer device, and a corresponding R_{eddy} value is stored in a memory of the wireless power transfer device at manufacture.

Determining friendly metal loss can further include use of at least one calibration factor.

A wireless power transmitter can include an inverter that receives a DC input voltage and a DC input current and produces an AC output voltage and an AC output current; a wireless power transmitting coil that receives the AC output voltage and AC output current from the inverter and is configured to induce an AC voltage in a wireless power receiving coil of a wireless power receiver; and transmitter control circuitry coupled to the inverter and the wireless power transmitting coil that measures one or more observable parameters associated with wireless power transfer between the wireless power transmitter and the wireless power receiver; determines flux in the wireless power transmitting coil of the wireless power transfer device from the measured one or more observable parameters; and determines friendly metal loss in the wireless power transmitter from the determined magnetic flux.

The one or more observable parameters can include one or more parameters selected from the group consisting of: inverter input voltage, inverter output voltage, inverter output current, wireless power transmitting coil current, operating frequency, and capacitance coupled to the wireless power transmitter coil. Determining flux in the wireless power transmitting coil can be performed in accordance with a formula of the form:

$$\vert ϕ \vert = \frac{\vert V \vert}{N \cdot 2 π {f}_{s}}$$

where |φ| is the RMS value of the magnetic flux, |V| is the RMS voltage across the wireless power transmitting coil, N is the number of turns in the wireless power transmitting coil, and fₛ is the frequency of the magnetic flux and voltage. Determining friendly metal loss in the wireless power transfer device from the determined magnetic flux can be performed in accordance with a formula of the form:

$${P}_{eddy} = {ϕ}^{2} \cdot {R}_{eddy}$$

where P_{eddy} is the friendly metal loss, φ is the determined magnetic flux, and R_{eddy} is a property of the wireless power transfer transmitter. R_{eddy} can be determined in accordance with a formula of the form:

$${R}_{eddy} = {N}^{2} \cdot \frac{{R}_{a i r} - {R}_{coil\_copper}}{{L}_{a i r}^{2}}$$

where Rₐᵢᵣ is a resistance of the wireless power transmitter coil in situ in the wireless power transmitter measured with the wireless power transmitter in free air, R_{coil_copper} is a DC resistance of the wireless power transmitter, and Lₐᵢᵣ is an inductance of the wireless power transmitter coil in situ in the wireless power transmitter measured with the wireless power transmitter in free air, and N is the number of turns in the wireless power transmitter coil. Rₐᵢᵣ, R_{coil_copper}, Lₐᵢᵣ, and N can be determined during design or manufacture of the wireless power transmitter, and a corresponding R_{eddy} value is stored in a memory of the wireless power transmitter at manufacture.

Determining friendly metal loss can further include use of at least one calibration factor.

The control circuitry of the wireless power transmitter can further use the friendly metal loss to determine and, if necessary, mitigate foreign object loss associated with the wireless power transfer between the wireless power transmitter and the wireless power receiver. The foreign object losses are determined in accordance with:

$${P}_{fo} = {P}_{i n} - {P}_{loss\_tx} - {P}_{fm\_tx} - {P}_{r e c e i v e d}$$

where P_{fo} are the foreign object losses, Pᵢₙ is inverter input power, P_{loss_tx} is inverter losses, P_{fm_tx} is P_{eddy}, and P_{received} is a value received from the wireless power receiver.

A wireless power receiver can include a wireless power receiving coil that configured to have an AC voltage induced therein by a wireless power transmitting coil of a wireless power transmitter; a rectifier that receives an AC input voltage and an AC input current from the wireless power receiving coil and produces a DC output voltage and a DC output current; and receiver control circuitry coupled to the rectifier and the wireless power receiving coil that measures one or more observable parameters associated with wireless power transfer between the wireless power transmitter and the wireless power receiver; determines flux in the wireless power receiving coil of the wireless power transfer device from the measured one or more observable parameters; and determines friendly metal loss in the wireless power receiver from the determined magnetic flux.

The one or more observable parameters can include one or more parameters selected from the group consisting of: rectifier input voltage, rectifier output voltage, rectifier output current, wireless power receiving coil current, operating frequency, capacitance coupled to the wireless power receiving coil. Determining flux in the wireless power receiving coil can be performed in accordance with a formula of the form:

$$\vert ϕ \vert = \frac{\vert V \vert}{N \cdot 2 π {f}_{s}}$$

where |φ| is the RMS value of the magnetic flux, |V| is the RMS voltage across the wireless power receiving coil, N is the number of turns in the wireless power receiving coil, and fₛ is the frequency of the magnetic flux and voltage. Determining friendly metal loss in the wireless power receiver from the determined magnetic flux can be performed in accordance with a formula of the form:

$${P}_{eddy} = {ϕ}^{2} \cdot {R}_{eddy}$$

where P_{eddy} is the friendly metal loss, φ is the determined magnetic flux, and R_{eddy} is a property of the wireless power receiver. R_{eddy} can be determined in accordance with a formula of the form:

$${R}_{eddy} = {N}^{2} \cdot \frac{{R}_{a i r} - {R}_{coil\_copper}}{{L}_{a i r}^{2}}$$

where Rₐᵢᵣ is a resistance of the wireless power receiving coil in situ in the wireless power receiver measured with the wireless power receiver in free air, R_{coil_copper} is a DC resistance of the wireless power receiving coil, and Lₐᵢᵣ is an inductance of the wireless power receiving coil in situ in the wireless power receiver measured with the wireless power receiver in free air, and N is the number of turns in the wireless power receiving coil. Rₐᵢᵣ, R_{coil_copper}, Lₐᵢᵣ, and N can be determined during design or manufacture of the wireless power receiver, and a corresponding R_{eddy} value is stored in a memory of the wireless power receiver at manufacture.

Determining friendly metal loss can further include use of at least one calibration factor.

The control circuitry of the wireless power receiver can determine a total power received in accordance with a formula of the form:

$${P}_{r e c e i v e d} = {P}_{rect} + {P}_{loss\_rx} + {P}_{fm\_rx}$$

where P_{received} is total power received by the wireless power receiver, P_{rect} is power delivered by the rectifier to the load, P_{loss_rx} is loss in the rectifier, and P_{fm_rx} is P_{eddy}. The control circuitry can communicate the total power received to the wireless power transmitter.

### BRIEF DESCRIPTION OF THE DRAWINGS

FIG. 1 illustrates a simplified block diagram of a wireless power transfer system.

FIG. 2 is a block diagram of a wireless power transfer system 200 illustrating various aspects of foreign object detection and friendly metal loss estimation.

FIG. 3 illustrates a flowchart of a technique for determining friendly metal loss in a wireless power transfer device.

FIG. 4 illustrates a flowchart 400 of a technique for estimating friendly metal and foreign object losses in a wireless power transfer device.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose. Any trademarks referenced herein are intended to only to identify examples and are property of their respective owners.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

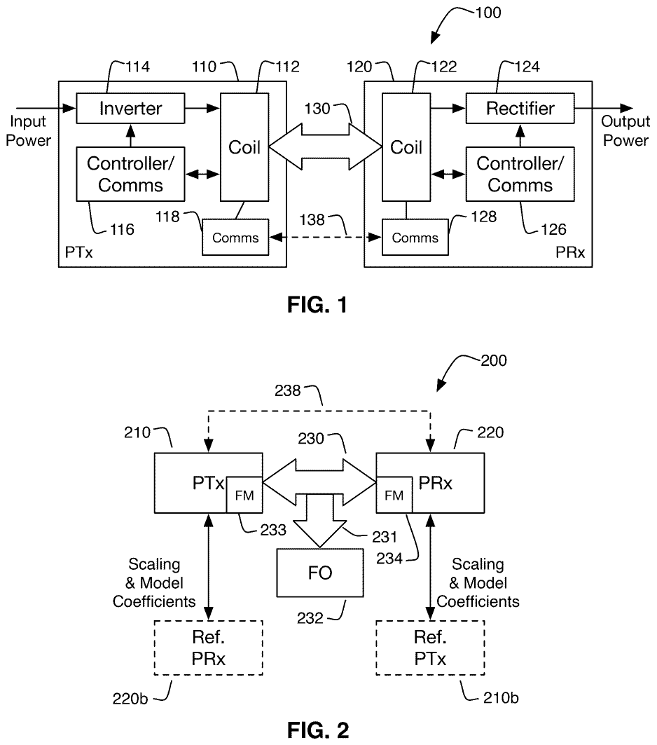

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the receiver, the transmitter coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transmitter coil may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications module 118. In some embodiments, comms module 118 may communicate with a corresponding module tag in the PRx via the power transfer coils. In other embodiments, comms module 118 may communicate with a corresponding module using a separate physical channel 138.

As noted above, wireless power transfer system also includes a wireless power receiver (PRx) 120. Wireless power receiver can include a receiver coil 122 that may be magnetically coupled 130 to the transmitter coil 112. As with transmitter coil 112 discussed above, receiver coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the receiver. This information may be received sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry. PRx device 120 may optionally include other systems and components, such as a communications (“comms”) module 128. In some embodiments, comms module 128 may communicate with a corresponding module in the PTx via the power transfer coils. In other embodiments, comms module 128 may communicate with a corresponding module or tag using a separate physical channel 138.

Numerous variations and enhancements of the above-described wireless power transmission system 100 are possible, and the following teachings are applicable to any of such variations and enhancements.

FIG. 2 is a block diagram of a wireless power transfer system 200 illustrating various aspects of foreign object detection and friendly metal loss estimation. In wireless power transfer applications, it may be desirable to estimate foreign object losses, that is, power transmitted by the PTx 210 that, instead of being received by the PRx 220, is dissipated in a foreign object 232. As described above, power transfer from PTx 210 to PRx 220 is via inductive coupling 230. Similarly, power dissipation in foreign object 232 is a result of inductive coupling 231 to the PTx and/or PRx. In any case, such foreign object losses may be used to detect the presence of a foreign object 232 and, if appropriate, reduce or suspend power transfer to prevent heating of the foreign object, etc.

Some foreign object detection techniques are based on power accounting principles. At a high level, such techniques take power transmitted by the PTx 210, subtract power received by the PRx 220, and subtract “known” losses associated with the system. The remaining power that is unaccounted for can be assumed to be the foreign object power. Such techniques may employ different techniques for estimating the “known” losses, which can be grouped into various categories, such as conduction losses and switching losses associated with the PTx, conduction losses and switching losses associated with the PRx, and so-called “friendly metal loss.” Friendly metal losses are associated with eddy currents induced by the magnetic field used for wireless power transfer in the metallic or otherwise conductive components of the PTx and PRx that are not part of the wireless power transfer circuitry. This can include housings, shielding, etc. Friendly metal associated with PTx 210 is represented by friendly metal block 233, and friendly metal associated with PRx 220 is represented by friendly metal block 234.

Friendly metal loss can be estimated by so-called curve fitting approaches. In general, such approaches measure one or more observable parameters of the wireless power transfer system and estimate friendly metal loss based on one or more friendly metal loss mathematical models derived from measurements or simulations of friendly metal loss and correlated with the one or more observable parameters. In at least some cases, a given PTx 210 or PRx 220 may have stored therein coefficients corresponding to such mathematical model and in operation a PTx or PRx can communicate its coefficients to its operating counterpart. To allow for interoperability between a wide range of PTx and/or PRx device types, ecosystem scaling principles may be employed. Various ecosystem scaling techniques exist, and, in general, such techniques allow each PTx 210 and/or PRx 220 to store scaling coefficients computed with reference to one or more known or standardized reference devices. Thus, for a given friendly metal loss model and measurements of the associated observable(s), the combination of the appropriate model coefficients for the PTx and PRx and scaling coefficients for the PTx relative to a reference PRx 220b and/or for the PRx relative to a reference PTx 210b can allow for estimation of the friendly metal loss.

The PTx 210 and PRx 220 can exchange required parameters via communication link 238, which can be an in-band or out-of-band communication link as was described above with reference to FIG. 1. The required parameters can include observable values (such as voltages, currents, power levels, etc.), coefficients (such as model coefficients or scaling coefficients), information about a particular model or models that should be used, various values calculated derived from the foregoing, etc. Then, one or both devices can derive an estimate of various losses, including friendly metal loss and foreign object losses, that can further be used to regulate or control the level of power transfer as appropriate.

Such curve-fitting approaches may perform better in cases in which the basic design and configuration of the PTx and/or PRx devices are similar to the reference designs. Thus, to allow for ecosystem expansion to include a large number of PTx and PRx devices, alternative friendly metal loss estimation techniques can be used.

One alternative friendly metal loss estimation technique can be based on the fact that the friendly metal losses are eddy current losses that are proportional to the magnetic flux in the associated coil. That is, PTx friendly metal 233 experiences eddy current losses that are induced by and proportional to the magnetic flux in the PTx coil (e.g., 112). Similarly, PRx friendly metal 234 experiences eddy current losses that are induced by and proportional to the magnetic flux in the PRx coil (e.g., 122). Faraday's law of induction may be expressed as:

$$V = - N \frac{d ϕ}{dt}$$

where V is the voltage across the coil, N is the number of turns in the coil, and dφ/dt is the time derivative of the magnetic flux. Thus, by integration,

$$\vert ϕ \vert = \frac{\vert V \vert}{N \cdot 2 π {f}_{s}}$$

where |φ| is the RMS value of the magnetic flux, |V| is the RMS voltage across the coil, N is the number of turns in the coil, and fₛ is the frequency of the flux/voltage. The PTx and/or PRx devices can thus calculate the flux in their own coil based on observations of the coil voltage and frequency. This observed flux can be used to estimate friendly metal loss as described in greater detail below.

More specifically, power loss due to eddy currents induced in the friendly metal can be estimated by:

$${P}_{eddy} \approx {ϕ}^{2} \cdot {R}_{eddy}$$

where P_{eddy} is the eddy current power loss, φ is the magnetic flux, and R_{eddy} is a property of the PTx or PRx device. This property is analogous to a resistance and is a function of the dimensions, materials, etc. of the device itself, specifically the configuration of conductive materials (i.e., friendly metal) that are affected by the flux in the coil (i.e., the wireless power transmitting coil of a PTx or the wireless power receiving coil of a PRx). R_{eddy} can further be defined as:

$${R}_{eddy} := \frac{{P}_{eddy}}{{ϕ}^{2}} = \frac{{R}_{f m} {I}^{2}}{{( \frac{L \cdot I}{N} )}^{2}} = {N}^{2} \cdot \frac{{R}_{f m}}{{L}^{2}} \approx {N}^{2} \cdot \frac{{R}_{a i r} - {R}_{coil\_copper}}{{L}_{a i r}^{2}}$$

where, in addition to the parameters defined above R_{fm} is the equivalent resistance of the friendly metal, I is the current in the coil while in free air (i.e., not affected by outside objects, such as a counterpart PTx or PRx or a foreign object), L is the inductance in the coil, Rₐᵢᵣ is the resistance of the coil in situ in the device (i.e., in the PTx or PRx) measured with the device in free air (i.e., not affected by outside objects, such as a counterpart PTx or PRx or a foreign object), R_{coil_copper} is the DC resistance of the coil itself, and Lₐᵢᵣ is the inductance of the coil in situ in the device (i.e., in the PTx or PRx) measured with the device in free air (i.e., not affected by outside objects, such as a counterpart PTx or PRx or a foreign object). These latter parameters (Rₐᵢᵣ, R_{coil_copper}, and Lₐᵢᵣ), along with N (the number of turns in the coil), are known or can be determined during design and/or manufacture of a PTx or PRx device. Thus, such parameters can be used to compute an R_{eddy} value that can be stored in the device at manufacture and used for friendly metal loss estimation when the device is in operation.

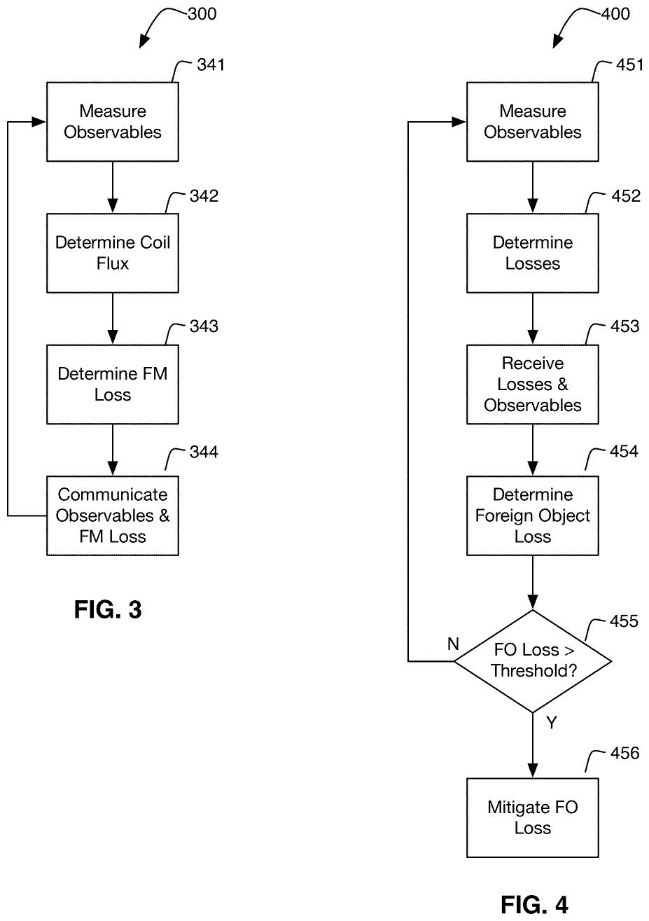

FIG. 3 illustrates a flowchart 300 of a technique for determining friendly metal loss in a wireless power transfer device (i.e., a PTx or PRx) as described above. Beginning at block 341, the device can use its control circuitry (e.g., PTx controller and communication circuitry 116 or PRx controller and communication circuitry 126 as described above) to measure one or more observables of a wireless power transfer system. For example, a PTx device could measure some combination of its inverter input voltage, inverter output voltage, inverter output current, wireless power transmitting coil current, operating frequency, capacitance coupled to the wireless power transmitter coil, etc. Similarly, a PRx device could measure some combination of its rectifier input voltage, rectifier output voltage, rectifier output current, wireless power receiving coil current, operating frequency, capacitance coupled to the wireless power receiver coil, etc. In either case, in block 342, the device, again using its control circuitry, can determine the flux in the device's coil, i.e., the wireless power transmitting coil in the case of a PTx device or the wireless power receiving coil in the case of a PRx device. For example, magnetic flux can be determined from the voltage and frequency and the number of turns in the coil (known apriori as a manufacturing parameter) as was described above.

In block 343, the device, again using its control circuitry, can determine the friendly metal loss corresponding to the determined magnetic flux. This can include the use of an R_{eddy} parameter as was described above, which can be determined during design and/or manufacture of the device and stored in a memory of the device so as to be available to the control and communication circuitry for use in block 343. More specifically, for a PTx device, the PTx friendly metal loss can be given by:

$${P}_{f {m}_{-} tx} = {R}_{eddy\_tx} \cdot {ϕ}_{tx}^{2}$$

where P_{fm_tx} is the friendly metal loss in the PTx, R_{eddy_tx} is the R_{eddy} parameter for the PTx, as described above, and φₜₓ is the wireless power transmitter coil flux computed as described above. Similarly, for a PRx device, the PRx friendly metal loss can be given by:

$${P}_{fm \_ rx} = {R}_{eddy \_ rx} \cdot {ϕ}_{r x}^{2}$$

where P_{fm_rx} is the friendly metal loss in the PRx, R_{eddy_rx} is the R_{eddy} parameter for the PTx, as described above, and φᵣₓ is the wireless power receiver coil flux computed as described above.

In some cases, an additional calibration factor can be included in the friendly metal loss estimation equation. Thus, for both PTx and PRx, the friendly metal loss can be given by:

$${P}_{fm} = α \cdot {R}_{eddy} \cdot {ϕ}^{2}$$

where α is a calibration factor and all other parameters are as described above. The calibration factor can be a scaling factor determined during design and/or manufacture of the device and stored in the device for use in the friendly metal loss estimation process. In some cases, an additional offset factor could be added to (or subtracted from) the scaled or unscaled product of R_{eddy} and φ. This offset factor could also be determined during design and/or manufacture of the device and stored in the device for use in the friendly metal loss estimation process.

In block 344, the device, again using its control circuitry, can communicate one or more observables and/or the determined friendly metal loss to another component of the wireless power transfer system. For example, in the case where foreign object detection is being performed by the PTx, the PRx may communicate one or more of its observables and the estimated PRx friendly metal loss (and/or one or more parameters derived therefrom) to the PTx for use in the foreign object detection scheme. Also, in the case where foreign object detection is being performed by the PTx, the PTx may “communicate” one or more of its observables and the estimated PTx friendly metal loss (and/or one or more parameters derived therefrom) to the foreign object detection scheme (which may be being performed by the same control circuitry). For example, a PRx, using its control circuitry, can determine its total power received according to the following:

$${P}_{r e c e i v e d} = {P}_{rect} + {P}_{loss \_ rx} + {P}_{fm \_ rx}$$

where P_{received} is the total power received by the PRx, P_{rect} is the power delivered by the rectifier to the load (i.e., the product of rectifier output voltage and rectifier output current), P_{loss_rx} are the losses in the rectifier (e.g., determined from other observables such as by subtracting the rectifier input power from the rectifier output power), and P_{fm_rx} is determined as described above. Once the PRx received power is communicated to the PTx, the PTx can determine the foreign object losses according to:

$${P}_{fo} = {P}_{i n} - {P}_{loss \_ tx} - {P}_{fm \_ tx} - {P}_{r e c e i v e d}$$

where P_{fo} are the foreign object losses, Pᵢₙ is the PTx inverter input power (e.g., the product of the input voltage and the inverter input current), P_{loss_tx} is the inverter losses (e.g., determined from other observables such as by subtracting the inverter output power from the inverter input power), P_{fm_tx} and P_{received} are determined as described above. This foreign object loss can be compared to a threshold to determine whether a foreign object is present and/or to trigger any appropriate mitigations as described in greater detail below.

Conversely, in the case where foreign object detection is being performed by the PRx, the PTx may communicate one or more of its observables and the estimated PTx friendly metal loss (and/or one or more parameters derived therefrom) to the PRx for use in the foreign object detection scheme. Also, in the case where foreign object detection is being performed by the PRx, the PRx may “communicate” one or more of its observables and the estimated PRx friendly metal loss (and/or one or more parameters derived therefrom) to the foreign object detection scheme (which may be being performed by the same control circuitry). The determination of various power levels, losses, etc. can be determined in accordance with equations similar to those described above. In any case, the process can repeat for so long as the wireless power transfer link remains established.

FIG. 4 illustrates a flowchart 400 of a technique for estimating friendly metal and foreign object losses in a wireless power transfer device (i.e., a PTx or PRx) as described above. Beginning at block 451, the device, using its control circuitry, can measure various observables as described above. In block 452, the device, again using its control circuitry can determine various losses. This can include determining friendly metal loss as described above with reference to FIG. 3, as well as determining other losses (such as PRx rectifier losses or PTx inverter losses) based on the measured observables. In block 453, the device can receive observables and determined losses from the counterpart device. As but one example, a PTx device could receive a P_{received} value from a PRx device that incorporates the power delivered to the load, the PRx circuitry losses (P_{loss_rx}), and the PRx friendly metal loss (P_{fm_rx}). Alternatively, the PTx could receive observables and/or other parameters necessary for the PTx to determine such values or other equivalents from observables or other data communicated by the PRx. In any case, in block 454, the PTx, using its control circuitry, can determine foreign object losses (P_{fo}), for example as described above. In block 455, the PTx, using its control circuitry, can compare the foreign object losses to a threshold. If the threshold is exceeded, mitigation of foreign object losses can be performed (block 456). These mitigations could include, for example, reducing the power transfer level to limit the power delivered to the foreign object and thus reducing the heating of such object. In more extreme cases, these mitigations could include temporarily or indefinitely suspending wireless power transfer. Otherwise, if the determined foreign object loss does not exceed the threshold, the process can repeat so long as the wireless power transfer link remains active.

Described above are various features and embodiments relating to wireless power transfer techniques to determine friendly metal loss during wireless power transfer between a PTx and a PRx. Such arrangements may be used in a variety of applications but may be particularly advantageous when used in conjunction with electronic devices such as mobile phones, tablet computers, laptop or notebook computers, and accessories such as wireless headphones, styluses, smart watches, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information between the PTx and PRx in the system. The present disclosure contemplates this passage of information improves the devices' ability to provide wireless power signals to each other in an efficient manner to facilitate battery charging, such as by sharing of the devices' power handling capabilities with one another. Entities implementing the present technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system and allow users to “opt in” or “opt out” of participation. For instance, such information may be presented to the user when they place a device onto a power transmitter, if the power transmitter is configured to poll for sensitive information from the power receiver.

1. A method of determining friendly metal loss in a wireless power transfer device, the method comprising:
measuring one or more observable parameters associated with wireless power transfer between the wireless power transfer device and a counterpart wireless power transfer device;
determining flux in a wireless power transfer coil of the wireless power transfer device from the measured one or more observable parameters; and
determining friendly metal loss in the wireless power transfer device from the determined magnetic flux;
wherein the friendly metal losses are used to determine and, if necessary, mitigate foreign object loss associated with the wireless power transfer between the wireless power transfer device and the counterpart wireless power transfer device.

2. The method of claim 1 wherein the wireless power transfer device is a wireless power transmitter, and the one or more observable parameters include one or more parameters selected from the group consisting of: inverter input voltage, inverter output voltage, inverter output current, wireless power transmitting coil current, operating frequency, and capacitance coupled to the wireless power transmitter coil.

3. The method of claim 1 wherein the wireless power transfer device is a wireless power receiver, and the one or more observable parameters include one or more parameters selected from the group consisting of: rectifier input voltage, rectifier output voltage, rectifier output current, wireless power receiving coil current, operating frequency, capacitance coupled to the wireless power receiving coil.

4. The method of claim 1 wherein determining flux in the wireless power transfer coil of the wireless power transfer device is performed in accordance with a formula of the form:
$$\vert ϕ \vert = \frac{\vert V \vert}{N \cdot 2 π {f}_{s}}$$
where |φ| is the RMS value of the magnetic flux, |V| is the RMS voltage across the coil, N is the number of turns in the coil, and fₛ is the frequency of the magnetic flux and voltage.

5. The method of claim 1 wherein determining friendly metal loss in the wireless power transfer device from the determined magnetic flux is performed in accordance with a formula of the form:
$${P}_{eddy} = {ϕ}^{2} \cdot {R}_{eddy}$$
where P_{eddy} is the friendly metal loss, φ is the determined magnetic flux, and R_{eddy} is a property of the wireless power transfer device.

6. The method of claim 5 wherein R_{eddy} is determined in accordance with a formula of the form:
$${R}_{eddy} = {N}^{2} \cdot \frac{{R}_{a i r} - {R}_{coil \_ copper}}{{L}_{a i r}^{2}}$$
where Rₐᵢᵣ is a resistance of the wireless power transfer coil in situ in the wireless power transfer device measured with the wireless power transfer device in free air, R_{coil_copper} is a DC resistance of the wireless power transfer coil, and Lₐᵢᵣ is an inductance of the wireless power transfer coil in situ in the wireless power transfer device measured with the device in free air, and N is the number of turns in the wireless power transfer coil.

7. The method of claim 6 wherein Rₐᵢᵣ, R_{coil_copper}, Lₐᵢᵣ, and N are determined during design or manufacture of the wireless power transfer device, and a corresponding R_{eddy} value is stored in a memory of the wireless power transfer device at manufacture.

8. The method of claim 5 wherein determining friendly metal loss further includes use of at least one calibration factor.

9. A wireless power transmitter comprising:
an inverter that receives a DC input voltage and a DC input current and produces an AC output voltage and an AC output current;
a wireless power transmitting coil that receives the AC output voltage and AC output current from the inverter and is configured to induce an AC voltage in a wireless power receiving coil of a wireless power receiver; and
transmitter control circuitry coupled to the inverter and the wireless power transmitting coil that:
measures one or more observable parameters associated with wireless power transfer between the wireless power transmitter and the wireless power receiver;
determines flux in the wireless power transmitting coil of the wireless power transfer device from the measured one or more observable parameters; and
determines friendly metal loss in the wireless power transmitter from the determined magnetic flux.

10. The wireless power transmitter of claim 9 wherein the one or more observable parameters include one or more parameters selected from the group consisting of: inverter input voltage, inverter output voltage, inverter output current, wireless power transmitting coil current, operating frequency, and capacitance coupled to the wireless power transmitter coil.

11. The wireless power transmitter of claim 9 wherein determining flux in the wireless power transmitting coil is performed in accordance with a formula of the form:
$$\vert ϕ \vert = \frac{\vert V \vert}{N \cdot 2 π {f}_{s}}$$
where |φ| is the RMS value of the magnetic flux, |V| is the RMS voltage across the wireless power transmitting coil, N is the number of turns in the wireless power transmitting coil, and fₛ is the frequency of the magnetic flux and voltage.

12. The wireless power transmitter of claim 9 wherein determining friendly metal loss in the wireless power transfer device from the determined magnetic flux is performed in accordance with a formula of the form:
$${P}_{eddy} = {ϕ}^{2} \cdot {R}_{eddy}$$
where P_{eddy} is the friendly metal loss, φ is the determined magnetic flux, and R_{eddy} is a property of the wireless power transfer transmitter.

13. The wireless power transmitter of claim 12 wherein R_{eddy} is determined in accordance with a formula of the form:
$${R}_{eddy} = {N}^{2} \cdot \frac{{R}_{a i r} - {R}_{coil \_ copper}}{{L}_{a i r}^{2}}$$
where Rₐᵢᵣ is a resistance of the wireless power transmitter coil in situ in the wireless power transmitter measured with the wireless power transmitter in free air, R_{coil_copper} is a DC resistance of the wireless power transmitter, and Lₐᵢᵣ is an inductance of the wireless power transmitter coil in situ in the wireless power transmitter measured with the wireless power transmitter in free air, and N is the number of turns in the wireless power transmitter coil.

14. The wireless power transmitter of claim 13 wherein Rₐᵢᵣ, R_{coil_copper}, Lₐᵢᵣ, and N are determined during design or manufacture of the wireless power transmitter, and a corresponding R_{eddy} value is stored in a memory of the wireless power transmitter at manufacture.

15. The wireless power transmitter of claim 12 wherein determining friendly metal loss further includes use of at least one calibration factor.

16. The wireless power transmitter of claim 12 wherein the control circuitry further uses the friendly metal loss to determine and, if necessary, mitigate foreign object loss associated with the wireless power transfer between the wireless power transmitter and the wireless power receiver.

17. The wireless power transmitter of claim 16 wherein the foreign object losses are determined in accordance with:
$${P}_{fo} = {P}_{i n} - {P}_{loss \_ tx} - {P}_{fm\_tx} - {P}_{r e c e i v e d}$$
where P_{fo} are the foreign object losses, Pᵢₙ is inverter input power, P_{loss_tx} is inverter losses, P_{fm_tx} is P_{eddy}, and P_{received} is a value received from the wireless power receiver.

18. A wireless power receiver comprising:
a wireless power receiving coil that configured to have an AC voltage induced therein by a wireless power transmitting coil of a wireless power transmitter;
a rectifier that receives an AC input voltage and an AC input current from the wireless power receiving coil and produces a DC output voltage and a DC output current; and
receiver control circuitry coupled to the rectifier and the wireless power receiving coil that:
measures one or more observable parameters associated with wireless power transfer between the wireless power transmitter and the wireless power receiver;
determines flux in the wireless power receiving coil of the wireless power transfer device from the measured one or more observable parameters; and
determines friendly metal loss in the wireless power receiver from the determined magnetic flux.

19. The wireless power receiver of claim 18 wherein the one or more observable parameters include one or more parameters selected from the group consisting of: rectifier input voltage, rectifier output voltage, rectifier output current, wireless power receiving coil current, operating frequency, capacitance coupled to the wireless power receiving coil.

20. The wireless power receiver of claim 18 wherein determining flux in the wireless power receiving coil is performed in accordance with a formula of the form:
$$\vert ϕ \vert = \frac{\vert V \vert}{N \cdot 2 π {f}_{s}}$$
where |φ| is the RMS value of the magnetic flux, |V| is the RMS voltage across the wireless power receiving coil, N is the number of turns in the wireless power receiving coil, and fₛ is the frequency of the magnetic flux and voltage.

21. The wireless power receiver of claim 18 wherein determining friendly metal loss in the wireless power receiver from the determined magnetic flux is performed in accordance with a formula of the form:
$${P}_{eddy} = {ϕ}^{2} \cdot {R}_{eddy}$$
where P_{eddy} is the friendly metal loss, φ is the determined magnetic flux, and R_{eddy} is a property of the wireless power receiver.

22. The wireless power receiver of claim 21 wherein R_{eddy} is determined in accordance with a formula of the form:
$${R}_{eddy} = {N}^{2} \cdot \frac{{R}_{a i r} - {R}_{coil \_ copper}}{{L}_{a i r}^{2}}$$
where Rₐᵢᵣ is a resistance of the wireless power receiving coil in situ in the wireless power receiver measured with the wireless power receiver in free air, R_{coil_copper} is a DC resistance of the wireless power receiving coil, and Lₐᵢᵣ is an inductance of the wireless power receiving coil in situ in the wireless power receiver measured with the wireless power receiver in free air, and N is the number of turns in the wireless power receiving coil.

23. The wireless power receiver of claim 22 wherein Rₐᵢᵣ, R_{coil_copper}, Lₐᵢᵣ, and N are determined during design or manufacture of the wireless power receiver, and a corresponding R_{eddy} value is stored in a memory of the wireless power receiver at manufacture.

24. The wireless power receiver of claim 21 wherein determining friendly metal loss further includes use of at least one calibration factor.

25. The wireless power receiver of claim 21 wherein the control circuitry determines a total power received in accordance with a formula of the form:
$${P}_{r e c e i v e d} = {P}_{rect} + {P}_{loss \_ rx} + {P}_{fm \_ rx}$$
where P_{received} is total power received by the wireless power receiver, P_{rect} is power delivered by the rectifier to the load, P_{loss_rx} is loss in the rectifier, and P_{fm_rx} is P_{eddy}.

26. The wireless power receiver of claim 25 wherein the control circuitry communicates the total power received to the wireless power transmitter.
